(19) United States
(12) Patent Application Publication
(10) Pub. No.: US 2014/0298101 A1
(43) Pub. Date: Oct. 2, 2014

(54) DISTRIBUTED PRESSURE TESTING SYSTEM AND METHOD

(71) Applicants: INVENTEC CORPORATION, Taipei (TW); INVENTEC (PUDONG) TECHNOLOGY CORPORATION, Shanghai (CN)

(72) Inventor: Yuan BAI, Shanghai (CN)

(73) Assignees: INVENTEC CORPORATION, Taipei (TW); INVENTEC (PUDONG) TECHNOLOGY CORPORATION, Shanghai (CN)

(21) Appl. No.: 14/227,196

(22) Filed: Mar. 27, 2014

(30) Foreign Application Priority Data
Mar. 29, 2013 (CN) 201310108785.X

(51) Int. Cl. G06F 11/26

(52) U.S. Cl. CPC G06F 11/26
USPC 714/37

(57) ABSTRACT

A distributed pressure testing system and method are disclosed, in which a test server transmits different test commands to corresponding test terminals so that the test terminals performing a pressure test on a unit under test according to the test commands, and the unit under test transmits the test result to the test server after the test server transmits a back-transmit request, so that the test server adjusts a pressure until the performance index meets up with the predetermined threshold parameter according to the test result. By means of the technical means of the present invention, an efficacy of increased test accuracy may be achieved.

### BACKGROUND OF THE RELATED ART

1. Technical Field

The present invention relates to a distributed pressure testing system, and particularly to a distributed pressure testing system where unit under test is tested for their pressures by controlling different test terminals by testing server.

2. Related Art

Recent years, with prevalence of Internet and development of cloud technology, servers have been largely arranged. Since the servers have their particular services, they have differences in specifications, arrangement environment, and component types. Therefore, a pressure test is a must process for assuring the server is satisfied with requirements.

Typically, the pressure test is performed by directly executing a test procedure on the server to test some performance index of the server. However, since the server is operated in a network environment, the test procedure does not take the network factors into consideration and thus causes a considerable error, forming a test accuracy issue.

In view of the above, a network-based pressure test manner has been proposed, in which the to-be-tested server and a test machine are connected through the network, and the test machine applies a pressure onto the server for the subject test. As such, the test accuracy may be increased by getting involved in the real network environment. However, the manner is merely a testing method for a single server, and cannot realistically simulate the test requests from all the associated equipment in a rack for satisfying the various test machines.

Therefore, the mentioned scheme still cannot effectively solve the problem of test accuracy.

In view of the above, it is known that there has long been a pressure test accuracy issue. Therefore, it is quite a need to set forth an effective means to improve this.

### SUMMARY

The present invention discloses a distributed pressure testing system and method.

According to the present invention, the distributed pressure testing system comprises K test terminals, each executing a test command after receiving the test command to generate and transmit a test data corresponding to a performance index, wherein K is a positive integer and larger than 1; a unit under test comprising servers or storage devices having different arrangements and connected to each other through a network, for receiving an activation message to activate at least a service process pre-set at the unit under test and detecting a state of the servers or storage devices when the service process processes the test data from the test terminals to produce a test result comprising all the performance indexes, and transmitting the test result upon receiving a back-transmit request.

The test server comprises a storage module, pre-storing a threshold parameter; an initialization module, transmitting the test commands at an initial stage to the test terminals, transmitting the activation message and the back-transmission request to the unit under test, and receiving the test result from the unit under test; a screening module, comparing the test result and the threshold parameter, and screening out one of the performance indexes other than meeting up with the threshold parameter; and an adjustment module, adjusting the test command transmitted to the corresponding unit under test, to adjust the corresponding test data until each of the performance indexes meets up with the threshold parameter.

According to the present invention, the distributed pressure testing method comprises steps of providing a threshold parameter at a test server in advance; transmitting, at an initial stage, a corresponding test command to each of K test terminals, respectively, transmitting an activation message and a back-transmit request to a unit under test by the server, wherein K is a positive integer and larger than 1, the unit under test comprises servers or storage devices connected to each other through a network and having different arrangements; executing the test command after receiving the test command at each of the test terminals, to generate and transmit a test data corresponding to a performance index; receiving the activation message by the unit under test to activate at least a service process pre-set at the unit under test and detecting a state of the servers or storage devices when the service process processes the test data from the test terminals to produce a test result comprising all the performance indexes, and transmitting the test result to the test server upon receiving a back-transmit request from the test server; comparing the test result and the threshold parameter, and screening out ones of the plurality of performance indexes other than meeting up with the threshold parameter by the test server; and adjusting the test command transmitted to each of the test terminals by the test server according to the screened performance index, to adjust the corresponding test data until each of the performance indexes meets up with the threshold parameter.

As compared to the prior art, the system and method of the present invention has the difference that the test server transmits different test commands to the corresponding test terminals so that the test terminal performing a pressure test on the unit under test according to the test commands, and the unit under test transmits the test result to the test server after the test server transmits a back-transmit request, so that the test server adjusts the pressure until the performance index meets up with the predetermined threshold parameter according to the test result.

By means of the technical means of the present invention, an efficacy of increased test accuracy may be achieved.

### BRIEF DESCRIPTION OF THE DRAWINGS

The invention will become more fully understood from the detailed description given herein below illustration only, and thus is not limitative of the present invention, and wherein:

FIG. 1 is a system block diagram of a distributed pressure test system according to the present invention;

FIG. 2A and FIG. 2B are a flowchart diagram of a distributed pressure test method according to the present invention;

FIG. 3 is a diagram of steps of the distributed pressure test method according to the present invention; and

FIG. 4A and FIG. 4B are a diagram of steps for using the distributed pressure test method according to the present invention as an application.

### DETAILED DESCRIPTION

The present invention will be apparent from the following detailed description, which proceeds with reference to the accompanying drawings, wherein the same references relate to the same elements.

In the following, the context is given to describe the present invention in details in connection with the annex drawings and the embodiments with respect to the features and implementations thereof, which is sufficient to enable those who skilled in the art readily to realize the technical mechanism intent to solve the technical problems and implement the same, so as to achieve in the efficacy exclaimed in the present invention.

Prior to the description dedicated to the distributed pressure testing system and method, the environment where the present invention is applied onto is first described. The present invention is applied onto an architecture comprising a test server, test terminals and a unit under test, which may be connected through a network or a connection cable for communications. In addition, the test server and the test terminals are all realized by a computer, which may be a personal computer (PC), a notebook computer, a tablet PC, smart cell phone, a personal digital assistant, etc. As to the unit under test, it refers to the overall equipment within a rack, comprising servers or storages with different arrangements.

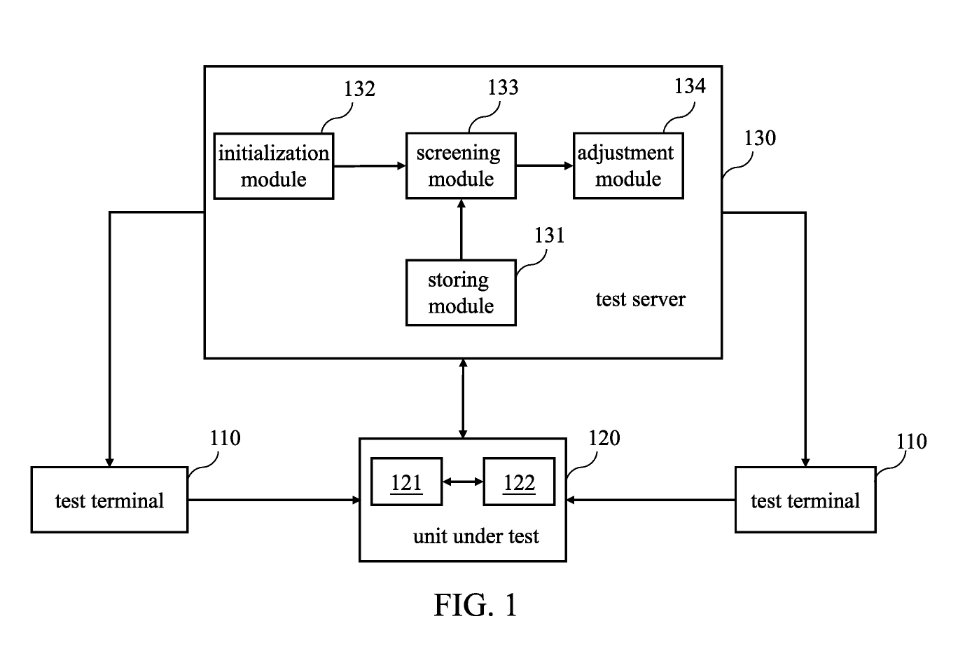

In what follows, the distributed pressure testing system and method will be described with reference to figures. Referring to FIG. 1 first, in which a system block diagram of the distributed pressure testing system and method is illustrated. The system comprises test terminals 110, a unit under test 120, and test server 130. The test terminals 110 each receives a test command, and executes the test command after receiving the test command, to generate and transmit a test data corresponding to a performance. For example, in the case where a central processing unit (CPU) is tested, the test terminals 110 may receive a test command for testing a computation ability of the CPU and execute the test command to generate a test data particularly for testing the CPU computation ability. Further, the test data is also transmitted to the unit under test. In real implementation, K test terminals 110 are used for different pressure tests, wherein K is a positive integer and larger than 1. In other words, the test terminals 110 is two in number or large than 2, each corresponding to its particular performance index and being used to test on the performance index.

The unit under test 120 comprises server 121 or storages 122 with different arrangements connected to one another through a network, such as a switchboard, for receiving an activation message to activate a service process preset in the unit under test, and detecting a state of the corresponding server 121 or storage device 122 when the service process processes the test data from all the test terminals 110. The unit under test 120 further generates a test result comprising all the performance indexes, and transmits the test result upon receiving a back-transmit request.

In real implementation, the unit under test is an end to be tested for the pressure. The unit under test 120 receives the activation message from the test server 130, for activating a service process preset at the unit under test 120, such as webpage service, file transmission service, etc. Then, the as-activated service process enables a state of the server 121 or storage device 122 when processing the test data to be detected. As such, the unit under test 120 may generate the test result comprising all the performance index, such as CPU use rate, memory use rate, frequency bandwidth use rate, etc. It is to be particularly note that the unit under test 120 may have its different hardware arrangement according to the different services. For example, the server 121 may be arranged with multiple CPUs in the case of a calculation service provided, the storage device 122 may be arranged with multiple hard disks in the case of a storing service provided.

As to the test server 130, it comprises a storing module 131, an initialization module 132, a screening module 133, and an adjustment module 134.

The storing module 131 pre-stores a threshold parameter, which comprises a performance index of the CPU, memory, hard disk and network frequency bandwidth. For example, the performance index of the CPU is recorded as “CPU;80%”, the memory as “MEM;50%”, the hard disk as “HDD;2%”, the network frequency bandwidth as “NET;10%”. In real implementation, the threshold parameter may be used to determine if each performance index falls outside a predetermined threshold, and further determine if a pressure under being tested should be adjusted. The adjustment manner is to adjust the test command transmitted to the test terminals 110, so as to adjust the test data corresponding thereto.

The initialization module 132 transmits the different test commands at an initial stage to the test terminals 110 and the activation message and a back-transmission request to the unit under test 120, and receives the test result from the unit under test 120. In real implementation, the initialization module 132 may first transmit the different test command to the corresponding test terminals 110, and transmit the activation message to the unit under test 120 to activate the service process at the unit under test 120. Then, the initialization module 132 further transmits the back-transmit request to the unit under test 120, requesting the unit under test 120 to transmit back the test result, and receives the test result transmitted back from the unit under test 120.

The screening module 133 compares the test result and the predetermined threshold parameter in the storing module 131, and screens out one or ones of the plurality of performance indexes does or do not meet up with the threshold parameter.

For example, assume the performance index recorded in the test result is “CPU;80%”, while the performance index recorded in the predetermined threshold parameter is “CPU;70%”. It represents that the CPU use rate beyond the threshold parameter, and it is determined the performance index does not meet up with the performance index associated with the threshold parameter. At this time, the performance index (CPU use rate) is screened out. It is to be particularly noted that the recording manner of the test result and the threshold parameter is not limited in the present invention. In other words, any manner which may compare the test result and the threshold parameter and determine if the threshold parameter has been exceeded belongs to the scope of the present invention.

The adjustment module 134 adjusts the test command transmitted to each corresponding one of the test terminals 110, to adjust the corresponding test data (i.e. adjust the test pressure) until each of the performance indexes meets up with the threshold parameter. In real implementation, assume only one performance index beyond the predetermined threshold (i.e. only one performance index is screened out), the adjustment module 134 adjusts the test command corresponding to the unscreened performance index to reduce the pressure to a half thereof. When the pressure is half out, and the screened performance index is still the same one, the adjustment module 134 adjusts again the test command corresponding to the performance indexes without being screened out to reduce the adjusted pressure to 10%.

When the pressure reduces to 10%, and the screened performance index is still the same one, the adjustment module 134 adjusts the test command corresponding to the screened performance index until the performance index is not screened out again. And, the test command corresponding to each of the unscreened performance indexes is adjusted to increase the pressure until the performance index does not meet up with the threshold parameter. It is to be particularly noted that when the pressure is reduced to a half or 10%, and the performance index is not screened out, the other unscreened performance indexes are adjusted to increase the pressure to an extent until the performance index does not meet up with the threshold parameter.

In addition, assume the adjustment module 134 first adjusts the test command of each of the screened performance indexes to reduce the pressure until the corresponding one of the screened performance indexes meet up with the threshold index when the screened performance index is multiple in number. Then, each of the screened performance indexes are adjusted, respectively.

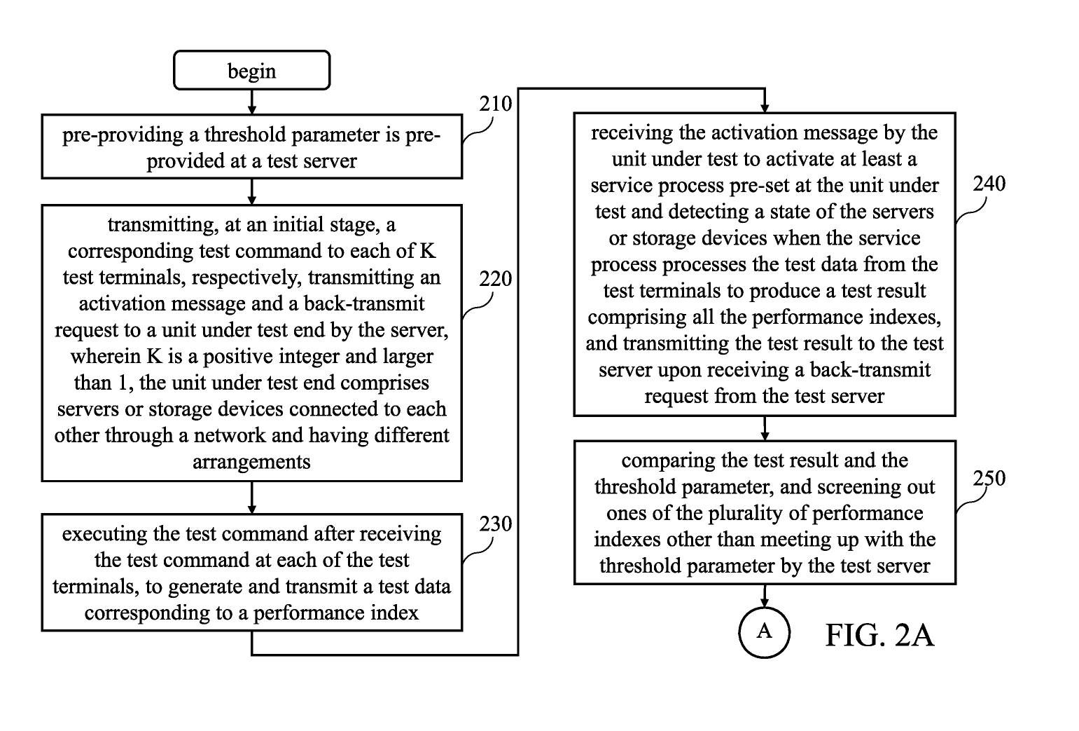

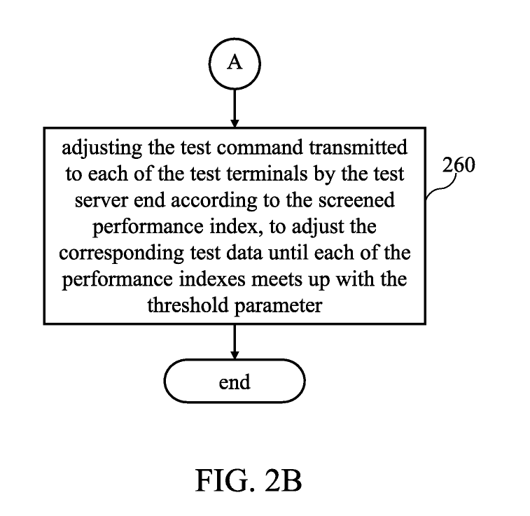

Thereafter, referring to FIG. 2A and FIG. 2B, which are a flowchart of the distributed pressure testing method according to the present invention. The method comprises the following steps.

At first, a threshold parameter is pre-provided at a test server (Step 210).

The test server 130 transmits, at an initial stage, a corresponding test command to each of K test terminals 110, respectively, and an activation message and a back-transmit request to the unit under test 120 (Step 220), wherein K is a positive integer and larger than 1, the unit under test comprises servers or storage devices connected to each other through a network and having different arrangements.

Each of the test terminals 110 executes the test command after receiving the test command, to generate and transmit a test data corresponding to a performance index (Step 230).

The unit under test 120 receives the activation message to activate at least a service process pre-set at the unit under test 120 and detects a state of the servers 121 or storage devices 122 when the service process processes the test data from the test terminals 110 to produce a test result comprising all the performance indexes, and transmits the test result to the test server 130 upon receiving a back-transmit request from the test server 130 (Step 240).

The test server 130 compares the test result and the threshold parameter, and one or ones of the plurality of performance indexes does or do not meet up with the threshold parameter is or are screened out (Step 250). The test server 130 adjusts the test command transmitted to each of the test terminals 110 by the test server according to the screened performance index, to adjust the corresponding test data until each of the performance indexes meets up with the threshold parameter (Step 260).

By performing the above steps, the different test commands may be transmitted to the corresponding test terminal 110 by the test server 130, each of the test terminals 110 tests the unit under test 120 in pressure according to the test command.

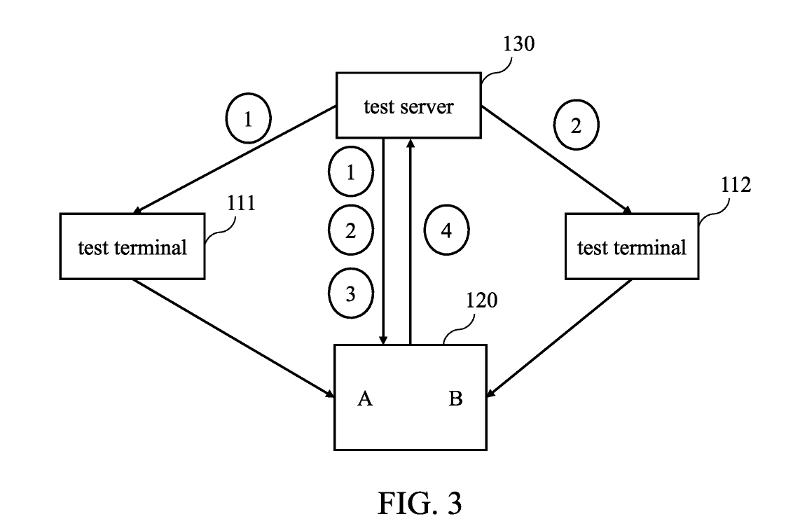

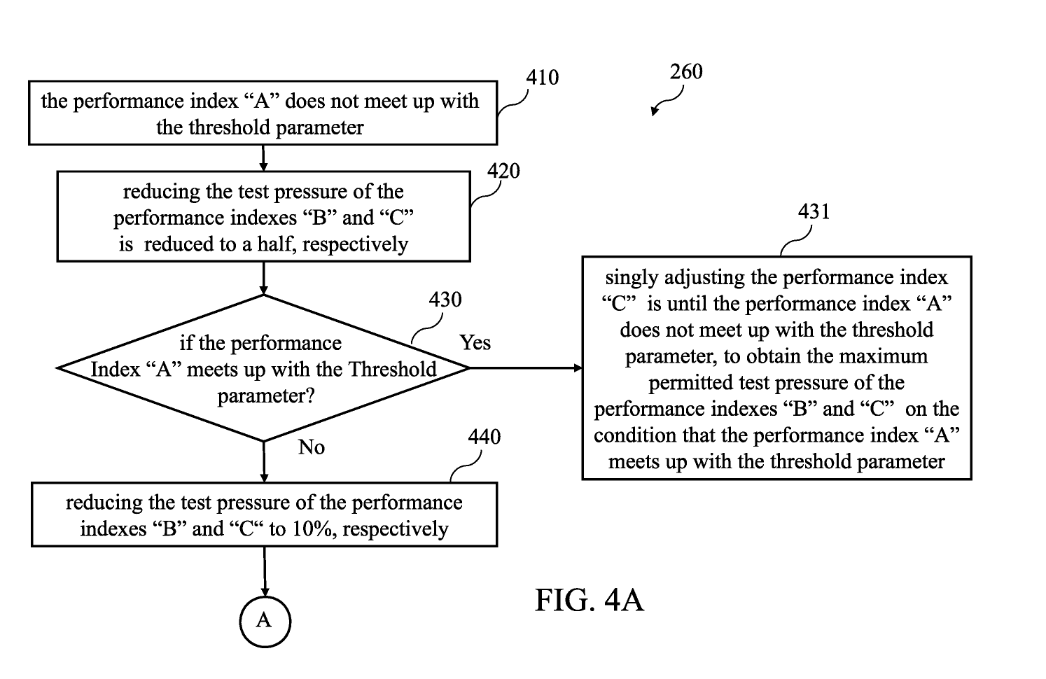

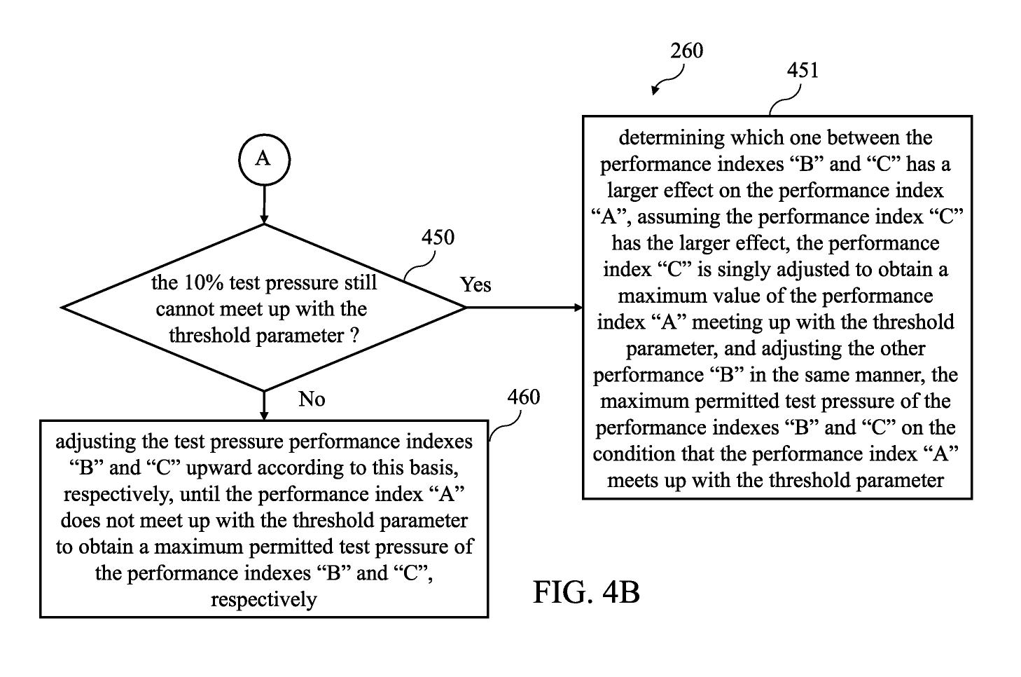

In the following, FIG. 3 to FIG. 4B are illustrated to describe an embodiment of the present invention. Referring to FIG. 3, in which a flowchart of the distributed pressure testing method according to the present invention is shown. In the description, “A” and “B” are the performance indexes of the service process provided by the unit under test 120. In this example, since the two performance indexes “A” and “B”, and thus two test terminals 110 are provided to perform the pressure test for the two corresponding performance indexes. The test server 130 comprises the following steps.

First, the test server 130 transmits the test command to the test terminal 111 and the activation message to the unit under test 120. Next, the test server 130 transmits the test command to the test terminal 112, and transmits the activation message to the unit under test 120. Then, the test server 130 transmits the back-transmit request to the unit under test 120. Finally, the test server 130 receives the test result transmitted back from the unit under test 120.

As shown in FIG. 4A and FIG. 4B, which are a diagram of steps for using the distributed pressure test method according to the present invention as an application. As mentioned above, the test server 130 may receive the test result transmitted back from the unit under test 120. At this time, the screening module 133 of the test server 130 compares the test result and the threshold parameter pre-stored in the storing module 131, and screens out the performance index without meeting up with the threshold parameter.

As far as the above example is concerned, assume the performance index “A” does not meet up with the threshold parameter, then the adjustment module 134 adjusts the test command transmitted to the test terminal 111 to adjust the corresponding test data until the performance index “A” meets up with the threshold parameter. In addition, the test command transmitted to the test terminal 112 may also be adjusted, to adjust the performance index “B” until the performance index “A” meets up with the threshold parameter. In addition, assume the number of the performance indexes is three, “A”, “B” and “C”. In the case that the performance index “A” does not meet up with the threshold parameter, the test command 111 transmitted to the test terminal 111, to adjust the corresponding test data until the corresponding performance index “A” meets up with the threshold parameter. At this time, it may be known with a maximum index reachable by the performance index “A” with the presence of the performance indexes “B” and “C”.

Next, the test commands of the performance indexes “B” and “C” are respectively adjusted, to see how the performance “A” may be adjusted to meet up with the requirement by adjusting one between “B” and “C”. It is to be particularly noted that when multiple performance indexes do not meet up with the threshold parameter, it is required to individually reduce the test pressure of the performance indexes without meeting up with the threshold index, and then the adjustment is made on each of such performance index.

In real implementation, assume the performance index “A” does not meet up with the threshold parameter (Step 410), after the test pressure of the performance indexes “B” and “C” may also be reduced to a half, respectively (Step 420), the performance index “A” is determined as to if it meets up with the threshold parameter (Step 430). Assume the half test pressure still does not meet up with the threshold parameter, the test pressure of the performance indexes “B” and “C” is reduced to 10%, respectively (Step 440). If the 10% test pressure still cannot meet up with the threshold parameter (Step 450), the performance index “A” is determined as to if it meets up with the threshold parameter (Step 450)? If the performance index “A” still does not meet up with the threshold parameter, the test pressure of the performance index “A” is reduced until it meets up with the threshold parameter. Then, the test pressure performance indexes “B” and “C” is adjusted upward according to this basis, respectively, until the performance index “A” does not meet up with the threshold parameter to obtain a maximum permitted test pressure of the performance indexes “B” and “C”, respectively, on the condition that the performance index “A” meets up with the threshold parameter (Step 460). The adjustment of the performance indexes “B” and “C” may be an upward adjustment, respectively.

As mentioned above, assume the performance index is determined as meeting up with the threshold parameter in the step 430, which one has a maximum effect on the performance index “A” is determined. Assume the performance index “C” has the maximum effect, the performance index “C” is singly adjusted until the performance index “A” does not meet up with the threshold parameter, to obtain the maximum permitted test pressure of the performance indexes “B” and “C” on the condition that the performance index “A” meets up with the threshold parameter (Step 431).

In addition, assume the performance index “A” is determined as meeting up with the threshold parameter in the step 450, which one between the performance indexes “B” and “C” has a larger effect on the performance index “A” is determined. Assume the performance index “C” has the larger effect, the performance index “C” is singly adjusted to obtain a maximum value of the performance index “A” meeting up with the threshold parameter. Thereafter, the other performance “B” is adjusted in the same manner, the maximum permitted test pressure of the performance indexes “B” and “C” on the condition that the performance index “A” meets up with the threshold parameter (Step 451). As such, the user may finish the pressure test task according to the test pressure adjusted by the test server 130 and test result transmitted back from the unit under test 120 according to the test pressure.

In summary, the system and method of the present invention has the difference as compared to the prior art that the test server transmits different test commands to the corresponding test terminals so that the test terminal performing a pressure test on the unit under test according to the test commands, and the unit under test transmits the test result to the test server after the test server transmits a back-transmit request, so that the test server adjusts the pressure until the performance index meets up with the predetermined threshold parameter according to the test result. By means of the technical means of the present invention, an efficacy of increased test accuracy may be achieved.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A distributed pressure testing system, comprising:
K test terminals, each executing a test command after receiving the test command to generate and transmit a test data corresponding to a performance index, wherein K is a positive integer and larger than 1;
a unit under test, comprising servers or storage devices having different arrangements and connected to each other through a network, for receiving an activation message to activate at least a service process pre-set at the unit under test and detecting a state of the servers or storage devices when the service process processes the test data from the test terminals to produce a test result comprising all the performance indexes, and transmitting the test result upon receiving a back-transmit request; and
a test server, comprising:
a storage module, pre-storing a threshold parameter;
an initialization module, transmitting the test commands at an initial stage to the test terminals, transmitting the activation message and the back-transmission request to the unit under test, and receiving the test result from the unit under test;
a screening module, comparing the test result and the threshold parameter, and screening out one of the performance indexes other than meeting up with the threshold parameter; and
an adjustment module, adjusting the test command transmitted to the corresponding unit under test, to adjust the corresponding test data until each of the performance indexes meets up with the threshold parameter.

2. The distributed pressure testing system as claimed in claim 1, wherein the adjustment module adjusts the test command corresponding to the performance indexes other than being screened out to half out a pressure when a number of the screened performance index is one, then adjusts again the test command corresponding to the performance indexes other than being screened out to reduce the adjusted pressure to 10% when the screened performance index is still the same one, and adjusts the test command corresponding to the screened performance index until the performance index is not screened out when the pressure reduces to 10% and the screened performance index is still the same one, and adjusts the test command corresponding to the screened performance index until the performance index is not screened out and adjusts the test command corresponding to the unscreened performance index, so as to increase the pressure until the performance index does not meet up with the threshold parameter.

3. The distributed pressure testing system as claimed in claim 1, wherein the adjustment module first adjusts the test command corresponding to each of the screened performance indexes to reduce the pressure when a number of the screened performance indexes is larger than one, to enable the performance index to meet up with the threshold parameter, and then adjusts each of the performance indexes literally.

4. The distributed pressure testing system as claimed in claim 2, wherein when the pressured is half out or reduced to 10% and the performance index is not screened out, the adjustment module adjusts other unscreened performance indexes, respectively, so as to increase the pressure until the threshold parameter is not met up with.

5. The distributed pressure testing system as claimed in claim 1, wherein the threshold parameter at least includes a performance index of a central processor, a memory, a hard disk and a network bandwidth.

6. The distributed pressure testing system as claimed in claim 1, wherein the servers or storage devices are disposed in a rack.

7. A distributed pressure testing method, comprising steps of:
providing a threshold parameter at a test server in advance;
transmitting, at an initial stage, a corresponding test command to each of K test terminals, respectively, transmitting an activation message and a back-transmit request to a unit under test by the server, wherein K is a positive integer and larger than 1, the unit under test comprises servers or storage devices connected to each other through a network and having different arrangements;
executing the test command after receiving the test command at each of the test terminals, to generate and transmit a test data corresponding to a performance index;
receiving the activation message by the unit under test to activate at least a service process pre-set at the unit under test and detecting a state of the servers or storage devices when the service process processes the test data from the test terminals to produce a test result comprising all the performance indexes, and transmitting the test result to the test server upon receiving a back-transmit request from the test server;
comparing the test result and the threshold parameter, and screening out ones of the plurality of performance indexes other than meeting up with the threshold parameter by the test server; and
adjusting the test command transmitted to each of the test terminals by the test server according to the screened performance index, to adjust the corresponding test data until each of the performance indexes meets up with the threshold parameter.

8. The distributed pressure testing method as claimed in claim 7, wherein the step of adjusting the test command transmitted to each of the test terminals by the test server according to the screened performance index comprises steps of:
adjusting the test command corresponding to the performance indexes other than being screened out to half out a pressure when a number of the screened performance index is one;
adjusting again the test command corresponding to the performance indexes other than being screened out to reduce the adjusted pressure to 10% when the screened performance index is still the same one;
adjusting the test command corresponding to the screened performance index until the performance index is not screened out when the pressure reduces to 10% and the screened performance index is still the same one; and
adjusting the test command corresponding to the screened performance index until the performance index is not screened out and adjusts the test command corresponding to the unscreened performance index, so as to increase the pressure until the performance index does not meet up with the threshold parameter.

9. The distributed pressure testing method as claimed in claim 7, wherein the step of adjusting the test command transmitted to each of the test terminals by the test server according to the screened performance index is performed by first adjusting the test command corresponding to each of the screened performance indexes to reduce the pressure when a number of the screened performance indexes is larger than one, to enable the performance index to meet up with the threshold parameter, and then adjusts each of the performance indexes literally.

10. The distributed pressure testing method as claimed in claim 8, wherein when the pressured is half out or reduced to 10% and the performance index is not screened out, the adjustment module adjusts other unscreened performance indexes, respectively, so as to increase the pressure until the threshold parameter is not met up with.

11. The distributed pressure testing method as claimed in claim 7, wherein the threshold parameter at least includes a performance index of a central processor, a memory, a hard disk and a network bandwidth.

12. The distributed pressure testing method as claimed in claim 7, wherein the servers or storage devices are disposed in a rack.
